(19) United States
(12) Patent Application Publication
(10) Pub. No.: US 2024/0051251 A1
(43) Pub. Date: Feb. 15, 2024

(54) die table segment

(71) Applicant: I HOLLAND LIMITED, Nottingham (GB)

(72) Inventors: Stephen John OSBORN, Nottingham (GB); Richard Allan Ball, Nottingham (GB)

(21) Appl. No.: 18/447,887

(22) Filed: Aug. 10, 2023

(30) Foreign Application Priority Data
Aug. 10, 2022 (GB) 2211699.0

(51) Int. Cl. B30B 11/08; B30B 15/02

(52) U.S. Cl. CPC B30B 11/08; B30B 15/026

(57) ABSTRACT

A die table segment for a tablet compression machine. The die table segment comprises a first component, for connection to a tablet compression machine. The first component comprises an inner radial face having a first radius of curvature. The die table segment comprises a second component comprising an outer radial face with a second radius of curvature which is greater than the first radius of curvature. The second component also comprises a plurality of through holes for forming tablets.

### CROSS REFERENCE TO RELATED APPLICATIONS

This application claims priority to GB2211699.0 filed Aug. 10, 2022, the entire contents of which are incorporated by reference herein.

### TECHNOLOGICAL FIELD

Embodiments of the present disclosure relate to a die table segment. Some relate to a die table formed from a plurality of die table segments.

### BACKGROUND

Tablet punches are used to press powders to form tablets. Generally, a tablet compression machine will include a plurality of tablet punches to press a batch of tablets of a particular material. The tablet compression machine may use a die table comprising a plurality of holes, each hole having a particular size to measure and contain the correct amount of powder to be used for each tablet. The tablet punches press the powders in the holes of the die table.

### BRIEF SUMMARY

According to various, but not necessarily all, embodiments there is provided a die table segment for a tablet compression machine. The die table segment comprises a first component, for connection to a tablet compression machine. The first component comprises an inner radial face having a first radius of curvature. The die table segment comprises a second component comprising an outer radial face with a second radius of curvature which is greater than the first radius of curvature. The second component also comprises a plurality of through holes for forming tablets.

The die table segment may comprise a fastener arrangement to couple the first and second components.

The fastener arrangement may directly couple the first and second components such that an outer radial face of the first component may be in contact with an inner radial face of the second component when the first and second components are coupled.

The fastener arrangement may comprise at least one fastener which extends through the first component when the first and second components are coupled.

The die table segment may comprise at least one alignment arrangement to align the first and second components.

The alignment arrangement may comprise at least one male connector and cooperating female connector.

The alignment arrangement may comprise one or more pins, and wherein the first and second components each comprise respective holes for receiving the one or more pins.

The one or more pins may form an interference fit with the first component and may form a push fit with the second component.

The male connector of the alignment arrangement may be formed on one of the first or second component, and the female connector may be formed in the other component such that the male connector may be received by the female connector when the first and second components are coupled.

The die table segment may comprise a third component having an inner radial face with a third radius of curvature substantially the same as the second radius of curvature and an outer radial face with a fourth radius of curvature. The fourth radius of curvature may be greater than the third radius of curvature.

The die table segment may comprise a further fastener arrangement to couple the second and third components.

The further fastener arrangement may comprise at least one fastener which extends radially through at least a portion of the third component when the second and third components are coupled together.

The third component may have a ledge. The ledge may extend to the outer radial face of the third component. The ledge may be for receiving tablets.

The third component may be made from a material different than the first and second components.

The third component may be formed from plastic.

The first component may comprise at least one recirculation groove. The first component may comprise a recirculation groove on each of an upper and lower face of the first component.

The first component may comprise at least one notch for fastening the first component to a tablet compression machine.

The plurality of through holes of the second component may be equally spaced. The plurality of through holes of the second component may extend from an upper face to a lower face of the second component.

At least a portion of the second component may be coated. The coating may be at least one of an anti-abrasion, anti-stick, anti-friction, and/or anti-corrosion coating.

The first component may be formed from a first material, and the second component may be formed from a second material, wherein the first and second materials are different.

The second component may be formed from a material having a high corrosion and wear resistance.

According to various, but not necessarily all, embodiments there is provided a die table for a tablet compression machine. The die table is formed from a plurality of die table segments. The die table is formed when the plurality of die table segments is aligned circumferentially.

According to various, but not necessarily all, embodiments there is provided examples as claimed in the appended claims.

### BRIEF DESCRIPTION

Some examples will now be described with reference to the accompanying drawings in which:

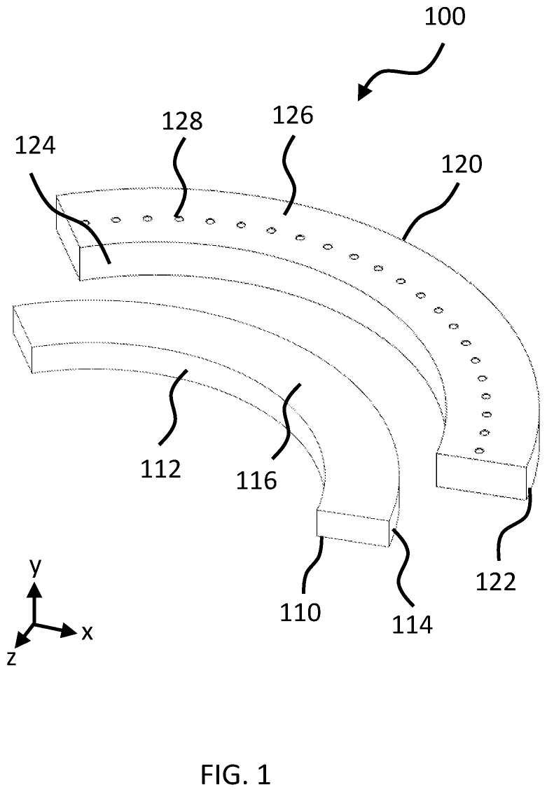

FIG. 1 shows an exploded view of a first example die table segment;

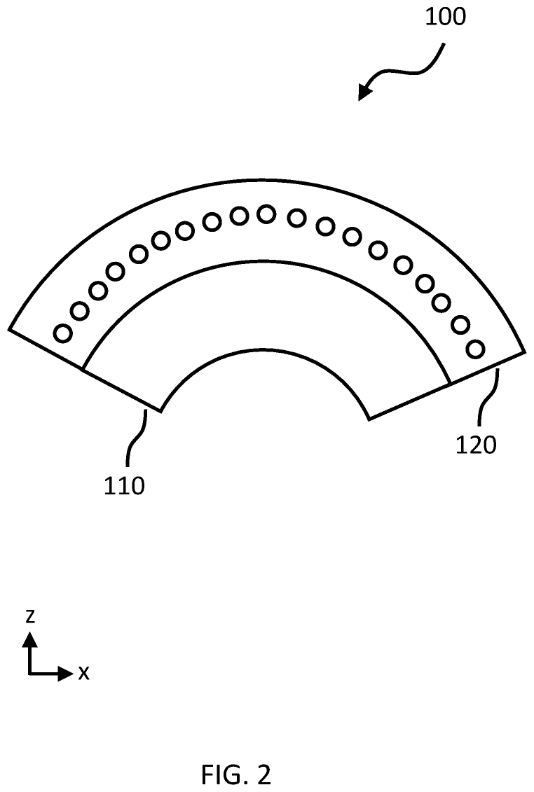

FIG. 2 shows a schematic diagram of the first example die table segment assembled;

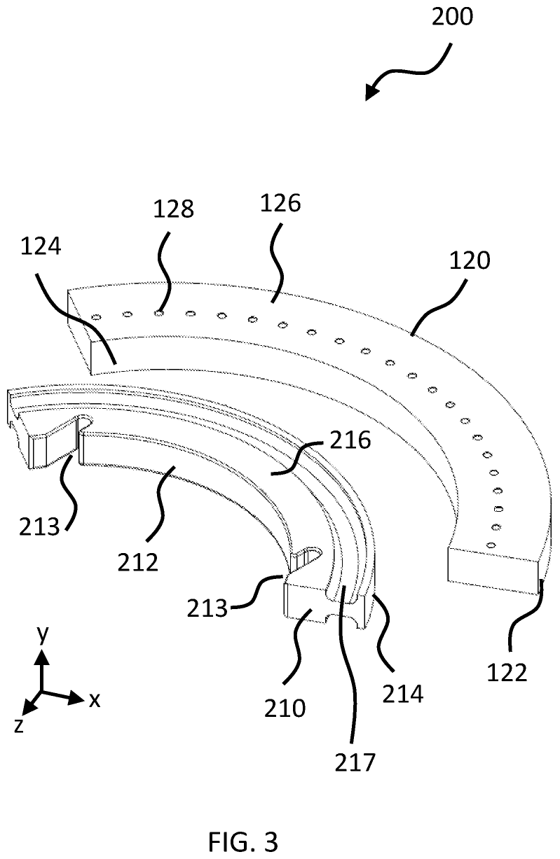

FIG. 3 shows an exploded view of a second example die table segment;

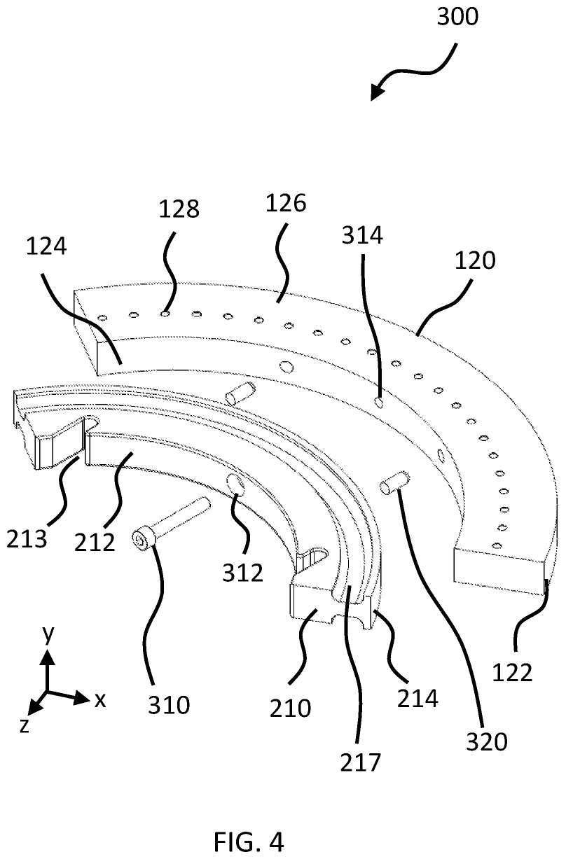

FIG. 4 shows an exploded view of a third example die table segment with a fastener arrangement and an alignment arrangement;

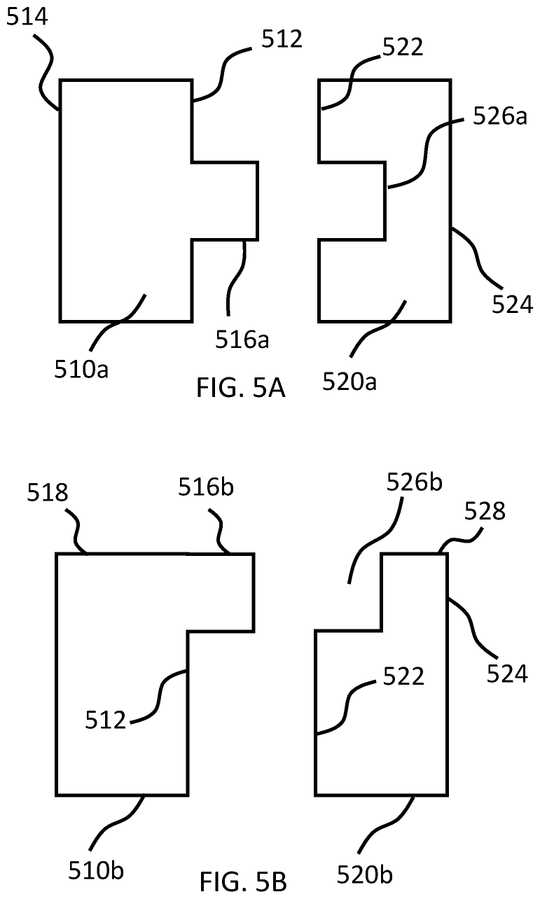

FIGS. 5A-B illustrate examples of male and female connectors for aligning;

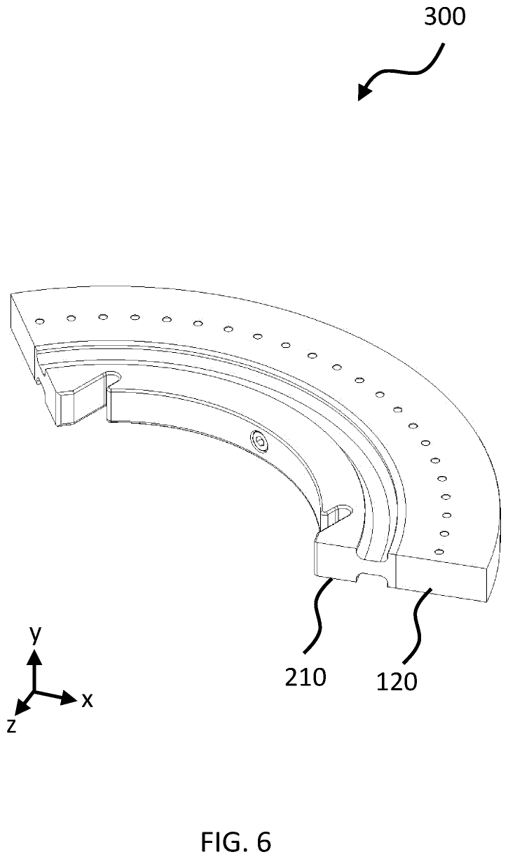

FIG. 6 shows a schematic diagram of the third example die table segment assembled;

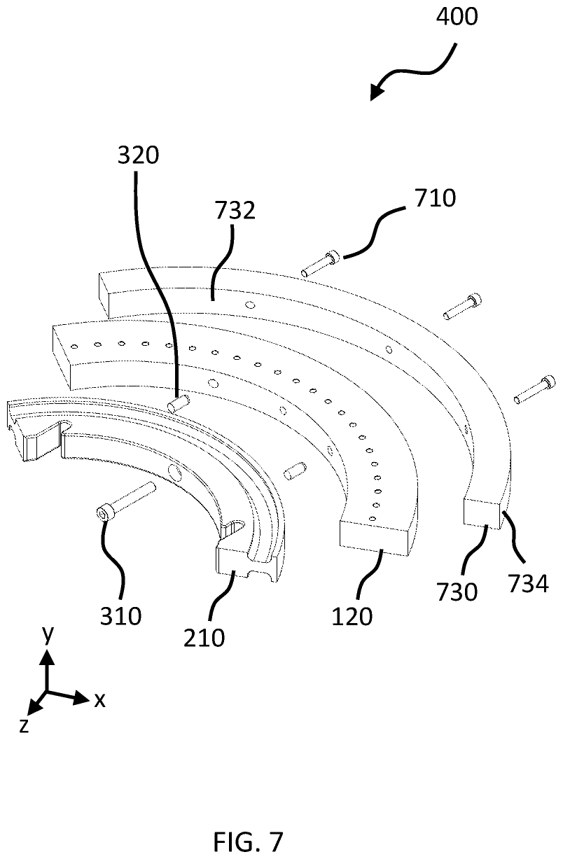

FIG. 7 shows an exploded view of a fourth example die table segment;

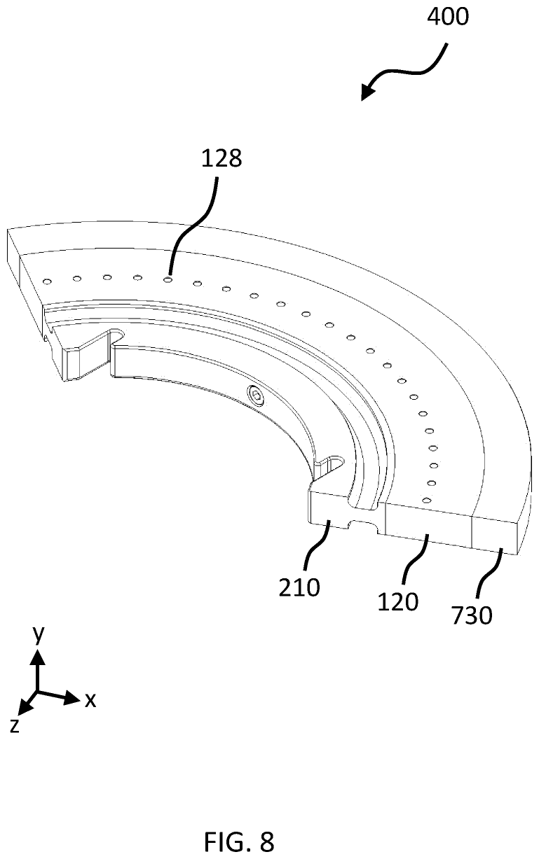

FIG. 8 shows a schematic diagram of the fourth example die table segment assembled;

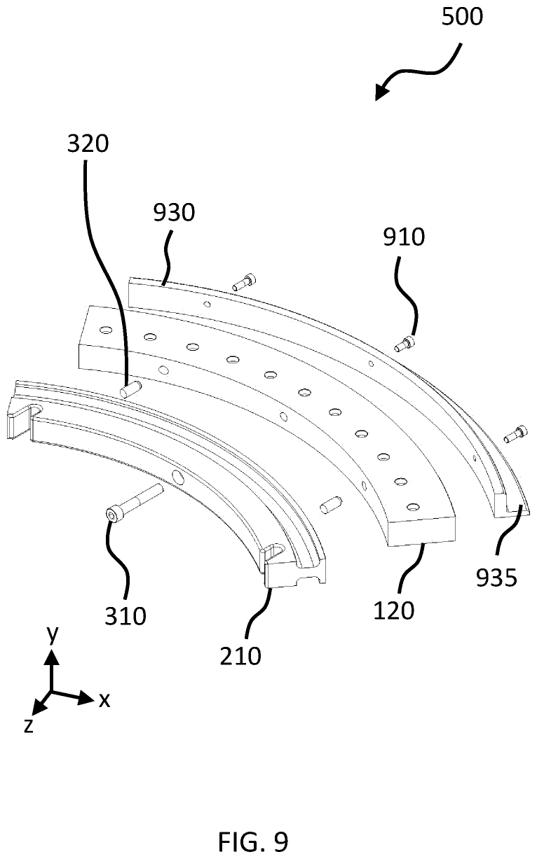

FIG. 9 shows an exploded view of a fifth example die table segment;

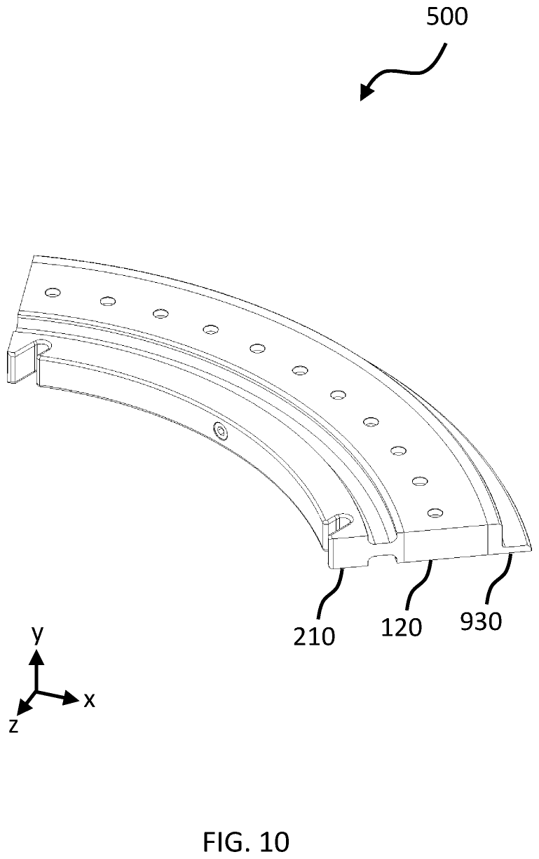

FIG. 10 shows a schematic diagram of the fifth example die table segment assembled;

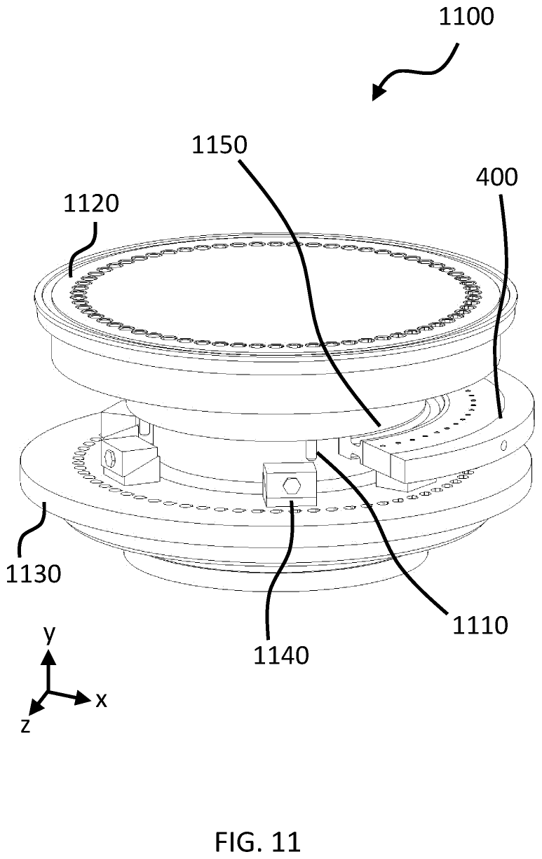

FIG. 11 shows a schematic diagram of a tablet compression machine with a fourth example die table segment installed; and

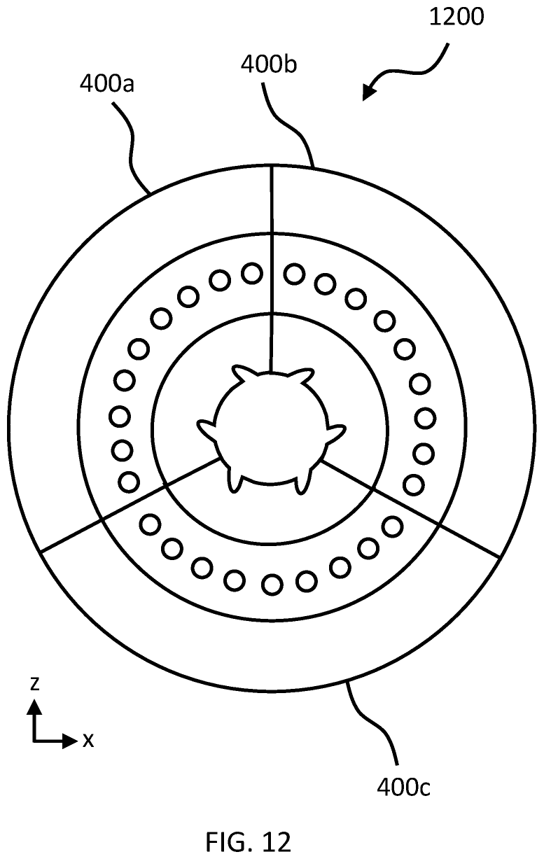

FIG. 12 shows a schematic diagram of a die table formed from a plurality of die table segments.

### DETAILED DESCRIPTION

Embodiments of the invention relate to a die table segment and a die table formed from a plurality of die table segments.

FIG. 1 shows an exploded view of a first example die table segment 100 for a tablet compression machine. The first example die table segment 100 comprises a first component 110 and a second component 120. The first 110 and second 120 components are to be coupled together. A schematic diagram of the first 110 and second 120 components coupled, i.e., directly coupled, is shown in FIG. 2. In particular, the first 110 and second 120 components are to be coupled either directly or indirectly in a radial-dimension, i.e., radially. In some embodiments, as described below, the first component 110 is for connection to a tablet compression machine.

In the illustrated examples, the first 110 and second 120 components are arc-shaped. The extent of the arc-length (as measured in an x-z plane in FIG. 1) depends upon the location, along the width of the component, at which the arc-length is measured. The first 110 and second 120 components have a constant width, (i.e., a constant thickness as measured radially in an x-z plane in FIG. 1), and a constant depth (as measured in in the y-dimension in FIG. 1).

In some examples, the thickness and/or depth of the component may vary. Generally, the arc-length is greater than the width and the depth, the width is shorter than the arc-length and longer than the depth, and the depth is shorter than the arc-length and the width (in each case, irrespective of where along the width the arc-length is measured).

In cylindrical coordinates, the arc-length of the illustrated components is aligned with the azimuthal-dimension and the width of the components is aligned with the radial-dimension. The depth of the components is aligned with the height-dimension, or the y-dimension.

In FIG. 1, the first component 110 comprises an inner radial face 112 having a first radius of curvature. The second component 120 comprises an outer radial face 122 with a second radius of curvature. The second radius of curvature is greater than the first radius of curvature. The inner radial face 112 of the first component 110 has a smaller arc-length than the outer radial face 122 of the second component 120.

The first component 110 also comprises an outer radial face 114, i.e., the face separated from the inner radial face 112 by the thickness of the first component 110. Similarly, the second component 120 comprises an inner radial face 124, i.e., the face separated from the outer radial face 122 by the thickness of the second component 120. The outer radial face 114 of the first component 110 and the inner radial face 124 of the second component 120 in FIG. 1 have substantially the same radius of curvature. In other words, the outer radial face 114 of the first component 110 and the inner radial face 124 of the second component 120 have substantially the same arc-length. As a result, when the first 110 and second 120 components are coupled together, the outer radial face 114 of the first component 110 is in direct contact with the inner radial face 124 of the second component 120, as shown in FIG. 2.

In the illustrated examples, the outer radial face 114 of the first component 110 and the inner radial face 124 of the second component 120 are shown to be smooth arcs, but any cooperating shape may be used for these faces.

The first 110 and second 120 components each comprise an upper face 116, 126. The upper faces 116, 126 are separated from lower faces by the depth of the components. Each of the upper and lower faces may define an edge with at least one radial face of the component. The upper face 126 of the second component 120 comprises a plurality of through holes 128 for forming tablets. In particular, the plurality of through holes 128 extend through the entire depth of the second component 120, i.e., extend from the upper face 126 to a lower face of the second component 120. The upper 126 and lower faces of the second component 120 each define an edge with the inner 124 and outer 122 radial faces of the second component 120.

In the illustrated example, the plurality of through holes 128 are positioned along the second component 120 in the x-z plane, and extend through the second component 120 in the y-dimension (which is orthogonal to the x- and z-dimensions). Each of the plurality of through holes 128 have the same radial value (i.e., distance in the radial-dimension) and a different azimuthal value. In particular, the plurality of through holes 128 are spaced, e.g., equally, in the azimuthal-dimension. In other words, the plurality of through holes 128 are spaced circumferentially. The plurality of through holes 128 are shown as circular in shape, but any shaped through hole may be used. In addition, the number of through holes 128 and/or their sizing (i.e., width and/or length) may differ from that shown in the illustrated second component 120. The plurality of through holes 128 not need be the same. For example, some through holes may have a different shape, and/or size.

The first 110 and second 120 components are formed, i.e., dimensioned, such that when coupled, the contact between the radial faces of the components, i.e., the outer radial face 114 of the first component 110 and the inner radial face 124 of the second component 120, forms a water-tight seal. In particular, the water-tight seal is formed along the azimuthal-dimension, i.e., along the arc-lengths of the radial faces (which are substantially the same). In some examples, a water-tight seal may only be formed, at least, proximal to the upper faces of the first 110 and second 120 components.

The first component 110 may be formed from a rigid material. In some examples, the first component 110 may be formed from metal, such as (e.g., stainless) steel, a ceramic, such as partially stabilised zirconium, or a rigid plastic, such as acetal, nylon or polytetrafluoroethylene. In some examples, the first component 110 may be formed from a composite material, for example comprising carbon fibre. The second component 120 may be formed from a rigid material. The second component 120 may be formed from a material with high corrosion and/or wear resistance. For example, the second component 120 may be formed from metal, such as (e.g., stainless) steel. In some examples, the first 110 and second 120 components are formed from the same material. In other examples, the first 110 and second 120 components are formed from different materials.

In some examples, a portion of the first 110 and/or second 120 component may be coated. For example, the upper and/or lower faces of the first 110 and/or second 120 component may be coated. Alternatively, or additionally, the plurality of through holes 128, or at least one through hole, of the second component 120 may be coated. In other examples, it may be that the first 110 and/or second 120 component is coated, i.e., the whole component. The coating may be at least one of an anti-abrasion, anti-stick, anti-friction and/or anti-corrosion coating. For example, the coating may be an anti-abrasion coating, such as an alloy or a ceramic. In some embodiments, a chromium or titanium-based coating may be used, such as Chromium Nitride or Titanium Nitride. Physical vapor deposition (PVD), chemical vapor deposition, or electroplating may be used to apply the coating. The coating may have a thickness of 0.5 to 10 μm, preferably 1 to 5 μm, more preferably 2 to 3.5 μm. In some examples, the coating may have a thickness of 3 μm or less, such as 2.8 μm.

The components of the first example die table segment enable interchangeability. For example, the through holes in each one of multiple second components might be of a different shape. Each of those second components may be couplable to the first component. The required second component may be selected and coupled to the first component for forming the desired tablets. In other words, the same first component may be used for forming tablets with different shapes.

FIG. 3 shows an exploded view of a second example die table segment 200 for a tablet compression machine. The second component 120 of the second example die table segment 200 is the same as the second component 120 for the first example die table segment 100 described above in relation to FIG. 1.

In the illustrated example of FIG. 3, the first component 210 of the second example die table segment 200 is similar to the first component 110 described above in relation to FIGS. 1 and 2. However, the first component 210 also comprises at least one recirculation groove 217 to recirculate powder. In other words, the recirculation groove 217 is for receiving excess powder, during operation, which is to be returned to a feeder of the tablet press machine, thereby recirculating the excess powder. In the illustrated example, the recirculation groove 217 extends along the azimuthal-dimension, i.e., from one end of the first component 210 to the other end. The illustrated first component 210 comprises a recirculation groove 217 on each of an upper face 216 and a lower face of the first component 210. Each of the upper and lower faces may define an edge with the inner radial face 212 and/or outer radial face 214 of the first component 210. In other examples, the first component 210 may only comprise a recirculation groove on only one of the upper or lower face.

The first component 210 may comprise at least one notch for fastening, and aligning, the first component 210 to a tablet compression machine. In the illustrated example, the first component 210 comprises two notches 213. Attachment of the first component 210 to the tablet compression machine is described in further detail below in relation to FIG. 11.

In other examples, the die table segment 200 may comprise an intermediate component (not shown) between the first 210 and second 120 components. It may be that the intermediate component comprises the recirculation groove or grooves, as described above. In other words, the first component may comprise at least one notch for connection to a tablet compression machine, and the intermediate component may comprise a recirculation groove, or recirculation grooves. The intermediate component may be similar in shape (e.g., arc-shaped) as the first 210 and second 120 components. It may be that the thickness of the first component and the intermediate component are smaller than the thickness of the second component. An inner radial face of the intermediate component may have a radius of curvature substantially the same as the outer radial face of the first component 210, and an outer radial face of the intermediate component may have a radius of curvature substantially the same as the inner radial face of the second component 120. In examples where the radial faces are not smooth arcs, the respective faces of the components may have corresponding shapes for coupling.

The intermediate component may be, partially or wholly, made from the same material as the first 110 and/or the second 120 components. Alternatively, the intermediate component may be made from a different material than the first 110 and second 120 components.

In further examples, the second component 120 may comprise the recirculation groove or grooves, as described above. In other words, the first component may comprise the notches for connection to a tablet compression machine, and the second component may comprise the recirculation groove, or recirculation grooves, and the plurality of through holes. In such examples, the curvature of radius of the inner radial face of the second component would be smaller than illustrated in FIGS. 1-3. In other words, the thickness of the second component would be greater. This allows the plurality of through holes to be located at the same radius of curvature, i.e., radial position, in order to be aligned with tablet punches of the tablet compression machine, as described below in relation to FIG. 11.

FIG. 4 shows an exploded view of a third example die table segment 300 for a tablet compression machine. The first 210 and second 120 components of FIG. 4 are similar to the first 210 and second 120 components of the second example die table segment 200 described above in relation to FIG. 3. The difference is that the components of FIG. 4 include a fastener arrangement to couple the first 210 and second 120 components and an alignment arrangement to align the first 210 and second 120 components when coupling, i.e., in the x-z plane.

In the illustrated example, the fastener arrangement comprises at least one fastener 310 and corresponding holes 312, 314 in the first 210 and second 120 components. The fastener arrangement directly couples the first 210 and second 120 components. In other words, the first 210 and second 120 components are in contact, i.e., direct contact, when coupled. Here, the outer radial face 214 of the first component 210 is in contact with the inner radial face 124 of the second component 120 when the first 210 and second 120 components are coupled, as shown in FIG. 6.

The fastener arrangement comprises at least one fastener 310, e.g., a bolt or a screw, which extends, at least partially, through a hole 312 in the first component 210. In the illustrated example, the first 210 and second 120 components are coupled when the at least one fastener 310 extends through the hole 312 in the first component 210 and is secured in a corresponding hole 314 in the second component 120, i.e., with threads. The fastener arrangement couples, e.g., rigidly couples, the first 210 and second 120 components. In the illustrated example, the fastener 310 extends through the thickness of the first component 210, i.e., (substantially) radially. In other words, the fastener 310 extends along the dimension defined by the width of the component. In other examples, a fastener 310 of the fastener arrangement may extend, at least partially, through the first component 210 at any angle in the x- and z-dimensions.

In other examples, the first 210 and second 120 components may be indirectly coupled, i.e., when the first 210 and second 120 components are not in direct contact when coupled. For example, when the die table segment comprises an intermediate component between the first 210 and second 120 components. In such examples, the fastener arrangement may include fasteners and corresponding holes to couple the first component 210 with the intermediate component, and fasteners and corresponding holes to couple the intermediate component with the second component 120. Alternatively, or additionally, the intermediate component may comprise a through hole which a fastener of the fastener arrangement may extend through, e.g., (substantially) radially. In other words, a fastener of the fastener arrangement may extend through the first 210 and intermediate components and be received by a corresponding hole, e.g., with threads, in the second 120 component.

FIG. 4 also illustrates an alignment arrangement to align the first 210 and second 120 components. In some examples, the alignment arrangement may be a part of the fastener arrangement (see for example the further fastener arrangement of FIGS. 7-10). The alignment arrangement comprises at least one male connector and a cooperating female connector. In this illustrated example, the alignment arrangement comprises two pins 320 (male connectors), and the corresponding holes (female connectors) of the alignment arrangement are formed in the first 210 and second 120 components for receiving the pins. The holes in the first 210 and second 120 components for receiving the pins 320 are substantially aligned with each other when the first 210 and second 120 components are coupled.

The pins 320 of the alignment arrangement may form an interference fit and/or a push fit with the first 210 and second 120 components. For example, the pins 320 may form an interference fit with the first component 210 and form a push fit with the second component 120.

Alternatively, or additionally, the alignment arrangement may comprise male connectors formed on and corresponding female connectors formed in the first 210 and second 120 components. Examples are shown in FIGS. 5A-B. In both FIGS. 5A and 5B, the male connector 516 is to be received by the female connector 526 when the first 510 and second 520 components are coupled. Therefore, the male 516 and female 526 connectors are positioned such that they align the components. The male connector 516 is illustrated as a protrusion and the female connector 526 as a corresponding indentation. The size and shape of the male 516 and female 526 connectors are substantially the same. The male 516 and female 526 connectors may, for example, form an interference fit or a push fit.

In the illustrated examples of FIGS. 5A-B, the first 510 and second 520 components may be the same as those described above. In particular, the first 510 and second 520 components are arc-shaped, and the first component 510 comprises an outer radial face 512 and an inner radial face 514, and the second component 520 comprises an inner radial face 522 and an outer radial face 524. The radius of curvature of the outer radial face 512 of the first component 510 is substantially the same as the radius of curvature of the inner radial face 522 of the second component 520.

The male connector 516a and corresponding female connector 526a in FIG. 5A are formed along the outer radial face 512 of the first component 510a and in the inner radial face 522 of the second component 520a, respectively. In FIG. 5B, the male connector 516b extends from the upper face 518 of the first component 510b and the corresponding female connector 526b extends into the upper face 528 of the second component 520b. Alternatively, or additionally, one or more male connectors may extend from the lower face rather than the upper face, and the corresponding female connector(s) may extend into the lower face. The male 516 and corresponding female 526 connectors align the first 510 and second 520 components.

In other examples, the male connector may be formed on the second component 520 and the female connector may be formed in the first component 510. Other examples may comprise a plurality of male and female connectors, e.g., spaced apart in an azimuthal- and/or depth-dimension, i.e., y-dimension. The alignment arrangement may comprise a combination of pins and connectors, and/or male and female connectors being formed on/in the first component with respective female and male connectors formed in/on the second component.

In other examples of FIG. 4, the fastener arrangement may comprise the alignment arrangement. For example, the fastener arrangement may comprise a plurality of fasteners 310, e.g., screws and/or bolts, and corresponding holes to couple the first 210 and second 120 components together. Here, the plurality of fasteners 310 and corresponding holes act to fasten the components together and align them.

Similar fastener arrangements and alignment arrangements may be used when an intermediate component is between the first and second components. A fastener arrangement and an alignment arrangement, as described above, may be used for the first and intermediate components, and/or the intermediate and second components. For example, the alignment arrangement may comprise one or more pins to fit into respective holes in the components, and/or the alignment arrangement may comprise male connectors extending from one or more of the components and corresponding female connectors in one or more components to receive the male connectors. Alternatively, or additionally, the fastener arrangement between the first and intermediate components, and/or between the intermediate and second components, may comprise the alignment arrangement.

FIG. 6 is a schematic diagram of the first 210 and second 120 components of the third example die table segment 300 coupled together. In this example, the first 210 and second 120 component are the same as described above in relation to FIG. 4 or 5. The first 210 and second 120 components are directly coupled, e.g., the outer radial face of the first component 210 is in direct contact with the inner radial face of the second component 120. Although not entirely visible, the fastener arrangement couples the first 210 and second 120 components, and the first 210 and second 120 components are aligned by the alignment arrangement when coupled.

The fastener arrangement described above is substantially aligned with the radial-dimension and the holes of the fastener arrangement (i.e., to receive the fastener) are located in the radial faces of the components. As the upper faces of the first 210 and second 120 components are in direct contact with powder during operation, the fastener arrangement is largely unexposed to the powder due to its placement. The coupling of the first 210 and second 120 components may therefore be achieved without the inclusion of holes in the upper and/or lower faces of the components.

In the illustrated examples, the first 210 and second 120 components are aligned in the x-z plane and in the azimuthal-dimension, i.e., the ends of the first component 210 align with the ends of the second component 120. In other examples, it may be that the fastener arrangement and alignment arrangement couple the first and second components such that the ends are not aligned. In other words, when coupled, one end of the first component 210 may be aligned, in the azimuthal-dimension, with any position along the inner radial face 124 of the second component 120, and one end of the second component 120 may be aligned, in the azimuthal-dimension, with any position along the outer radial face 214 of the first component 210. For example, one end of the first component 210 may be aligned with the centre of the inner radial face 124 of the second component 120.

In some examples, the die table segment may be assembled on a location fixture.

The die table segments described above in relation to FIGS. 1-6 may be suitable for a contained tablet compression machine. In such machines, the thickness of the die table segment (i.e., the thickness of the first and second components combined, when coupled) is restricted. The thicknesses of the first and second components may therefore be selected to ensure that the total thickness of the die table segment is suitable for a contained tablet compression machine. The same total thickness also applies when an intermediate component is between the first and second components.

In contrast, the die table segments described below in relation to FIGS. 7-12 may be suitable for an uncontained tablet compression machine. Here, the thickness of the die table segment may exceed the thickness required for an uncontained tablet compression machine.

FIG. 7 is an exploded view of a fourth example die table segment 400. In particular, the first 210 and second 120 components are similar to those described above in relation to FIGS. 4-6. The difference is that the die table segment 400 comprises a third component 730 and a further fastener arrangement to couple the second 120 and third 730 components. The second component 120 therefore differs in that the outer radial face of the second component 120 comprises respective holes (not shown) for receiving fasteners 710 of the further fastener arrangement.

The third component 730 is similar to the first and second components described above. The third component 730 comprises an inner radial face 732 with a third radius of curvature substantially the same as the second radius of curvature, and an outer radial face 734 with a fourth radius of curvature. The fourth radius of curvature is greater than the third radius of curvature. The inner radial face 732 is separated from the outer radial face 734 by the thickness of the third component 730.

The further fastener arrangement comprises at least one fastener which extends, e.g., radially, through at least a portion of the third component 730 when the second 120 and third 730 components are coupled together. The further fastener arrangement may be the same as described above in relation to the fastener arrangement for coupling the first 210 and second 120 components.

The further fastener arrangement of FIG. 7 comprises three fasteners 710, e.g., screws and/or bolts. Each fastener 710 extends through the third component 730 when the second 120 and third 730 components are coupled. It may be that each fastener 710 of the further fastener arrangement extends through the third component 730 in a dimension defined by the thickness of the third component 730, i.e., radially. In other examples, the further fastener arrangement may extend through the third component 730 at any angle in the x- and z-dimensions. In the illustrated example, the fasteners 710 of the further fastener arrangement extend through the third component 730 at the same angle in the x- and z-dimensions.

In the illustrated example, the further fastener arrangement also acts as an alignment arrangement for the second 120 and third 730 components. In other examples, a further alignment arrangement may be used between the second 120 and third 730 components. The further alignment arrangement may be as described above in relation to the alignment arrangement between the first 210 and second 120 components.

The third component 730 may be formed from a rigid material. In some examples, the third component 730 may be formed from metal, such as (e.g., stainless) steel, a ceramic, such as partially stabilised zirconium, or a rigid plastic, such as acetal, nylon, or polytetrafluoroethylene. In some examples, the third component 730 may be formed from a composite material, for example comprising carbon fibre. The first, second and third components may be formed of the same material. In some examples, the third component may be formed from a material different than the first and second components. In other examples, the first and third components may be formed of the same material which is different than the material used for the second component. In other examples, the second and third components may be formed of the same material which is different than the material used for the first component. In further examples, each of the first, second and third components may be formed from different materials.

In some examples, a portion of the third component 730, or the whole third component 730, may be coated. For example, the upper and/or lower faces of the third component 730 may be coated. The coating may be as described above in relation to the first and second components.

FIG. 8 is a schematic diagram of the first 210, second 120 and third 730 components coupled together using the fastener arrangement and the further fastener arrangement. In this example, the first 210, second 120 and third 730 components are the same as described above in relation to FIG. 7. The first 210 and second 120 components are directly coupled, i.e., the outer radial face of the first component is in contact with the inner radial face of the second component. Although not entirely visible, the fastener arrangement couples the first 210 and second 120 components, and the first 210 and second 120 components are aligned by the alignment arrangement when coupled. The second 120 and third 730 components are directly coupled, i.e., the outer radial face of the second component 120 is in contact with the inner radial face of the third component 730. Although not visible, the further fastener arrangement couples and aligns the second 120 and third 730 components. The first 210, second 120 and third 730 components are coupled and aligned in the x-z plane.

In this example, the third component 730 is coupled to the second component 120 such that the upper face of the second 120 and third 730 components are level. This therefore allows, during operation, tablets ejected from the plurality of through holes 128 in the second component 120 to, e.g., seamlessly, move across to the upper face of the third component 730, for example through the use of a scraper on, or attached to, the tablet compression machine. The die table segment 400 described in relation to FIG. 7 is suitable for tablet compression machines which have two take off bars. In other words, tablets may be removed from the tablet compression machine at two locations around the circumference of the tablet compression machine.

In a similar manner as described above, the second 120 and third 730 components may be formed, i.e., dimensioned, such that when coupled, the contact between the radial faces of the components, i.e., the outer radial face 122 of the second component 120 and the inner radial face 732 of the third component 730, forms a water-tight seal. In particular, the water-tight seal is formed along the azimuthal-dimension, i.e., along the arc-lengths of the radial faces (which are substantially the same). In some examples, a water-tight seal may only be formed, at least, proximal to the upper faces of the second 120 and third 730 components.

FIG. 9 is an exploded view of a fifth example die table segment 500. The die table segment 500 is similar to the die table segment 400 described above in relation to FIGS. 7-8. The difference is that the third component 930 comprises a ledge 935 and the fasteners 910 of the further fastener arrangement are smaller in length compared with the fasteners 710 illustrated in FIG. 7. This is because the fasteners 910 illustrated in FIG. 9 extend through a smaller thickness of the third component 930 due to the ledge 935.

The ledge 935 extends to the outer radial face of the third component 930. In other words, the third component 930 has an L-shaped cross section. The thickness of the upper face of the third component 930 is therefore smaller than the thickness of the lower face of the third component 930. In the illustrated example, the thickness of the lower face of the third component 930 is the same as the combined thickness of the upper face and the ledge 935.

The ledge 935 of the third component 930 is for receiving tablets. In particular, the ledge 935 is for receiving tablets ejected from the plurality of through holes 128 in the second component 120, i.e., formed tablets. Therefore, the thickness of the ledge 935, which is the same as the thickness, i.e., width, of the free space in the third component 930, exceeds the largest dimension of the formed tablets. This is based, in part, on the size of the plurality of through holes 128 in the second component 120.

During operation, the outer radial face of the third component 930 abuts against a wall of the tablet compression machine. Tablets ejected from the plurality of through holes 128 in the second component 120 are received in the ledge 935, due to rotational forces or a scraper. The ledge 935 contains the tablets until the tablets are removed from the tablet compression machine, i.e., by a take off bar. In this example, the die table segment 500 of FIG. 9 is suitable for tablet compression machines comprising only one take off bar, i.e., machines which remove tablets at only one location around the circumference of the tablet compression machine. For example, the wall of the tablet compression machine which the outer radial face of the third component 930 abuts against, may comprise an opening to allow the tablets to be removed.

In a similar manner as described above in relation to FIG. 8, FIG. 10 is a schematic diagram of the first 210, second 120 and third 930 components coupled together.

In the illustrated examples of FIGS. 8 and 10, the first 210, second 120 and third 930 components are aligned in the x-z plane and in the azimuthal-dimension, i.e., the ends of the first component 210 align with the ends of the second component 120 and third component 730. In other examples, it may be that the fastener arrangement and alignment arrangement couple the first and second components such that the ends are not aligned, as described above. In addition, or alternatively, the further fastener arrangement may couple the second and third components in a similar manner such that the ends are not aligned.

In FIGS. 7-10, the die table segments are described as comprising three components. In other examples, it may be that the second component has a thickness to thereby act as both the second and third components described above. In other words, the second component may have a thickness equal to the combined thickness of the second and third components. In such examples, the location of the plurality of through holes would be the same as illustrated above. In other words, the plurality of through holes may be located at the same radius of curvature, i.e., at the same distance from the inner radial face of the first component, as examples described above. This therefore aligns the plurality of through holes with the tablet punches of the tablet compression machine. Additionally, the second component may comprise a ledge which performs in the same manner as the ledge 935 of the third component 930 described above in relation to FIG. 9.

The components described above for each of the example die table segments enables reusability of the components for different tablet compression machines. In particular, the components may be used for a contained tablet compression machine, when the first and second components are used, and an uncontained tablet compression machine, when the first, second and third components are used. The reusability relates to coupling or decoupling the third component, while the first and second components may be the same. Similarly, the same first and second components may be used for tablet compression machines with one take off bar or with two take off bars, i.e., by interchanging the third component from one with a ledge to one without a ledge. Additionally, or alternatively, the first and third components may be the same and the second component may be interchanged depending on the required shape and/or size of the tablets. This therefore enables reusability and interchangeability of the components.

FIG. 11 illustrates an example of a portion of a tablet compression machine 1100 with a single, assembled die table segment 400 connected to the tablet compression machine 1100. In particular, the fourth example die table segment 400 is the same as described above in relation to FIGS. 7 and 8, i.e., comprising three components where the third component 730 does not comprise a ledge. Although shown with a fourth example die table segment 400, any of the example die table segments may be connected to the tablet compression machine 1100.

The tablet compression machine 1100 comprises a plurality of protrusions 1110 which are to be received by notches 213 in the first component 210 when the die table segment 400 is connected, or being connected, to the tablet compression machine 1100. This aligns the placement of the die table segment 400. In particular, when the die table segment 400 is connected to the tablet compression machine 1100, the plurality of through holes 128 in the second component 120 is aligned with tablet punches (not shown) installed in upper 1120 and lower 1130 punch guides in turrets of the tablet compression machine 1100, i.e., aligned in the y-dimension.

In the illustrated example, the tablet compression machine 1100 also comprises a plurality of clamping wedges 1140 which secure the die table segment 400 to the tablet compression machine 1100. When the protrusions 1110 are received by notches 213 in the first component 210, tightening the clamping wedges 1140 under the die table segment 400 causes the die table segment 400 to move, i.e., in the (positive) y-dimension. In particular, the die table segment 400 moves such that the upper face of the first component 120 abuts against an overhang 1150 of the tablet compression machine 1100. The tightened clamping wedges 1140 secure the die table segment 400 to the tablet compression machine 1100 and ensure that the plurality of through holes 128 remain aligned with tablet punches installed, or to be installed, in the tablet compression machine.

A similar process is performed for additional die table segments to complete a die table. In some examples, three die table segments may form a complete die table. In other examples, five die table segments may for a complete die table.

FIG. 12 is a schematic diagram of a die table 1200 for a tablet compression machine. The die table 1200 is formed from a plurality of die table segments. In the illustrated example, the die table 1200 is formed when the plurality of die table segments is aligned, in the azimuthal-dimension, i.e., circumferentially.

In this example, the die table segments are the fourth example die table segment 400 as described above in relation to FIGS. 7-8, but any other example die table segment may be used. The number of die table segments 400 which form the die table 1200 depends on the size of the tablet compression machine and the dimensions of the die table segments, e.g., the arc-lengths of the die table segments. In this example, the die table 1200 is formed from three die table segments 400a-c. In other examples, the die table 1200 may be formed from five die table segments.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims. For example, the number of through holes in the second component 120 need not be the same as those illustrated in FIGS. 1-4 and 6-12. The spacing, shape and/or size of the through holes need not be the same as those illustrated in FIGS. 1-4 and 6-12. The radius of curvatures of the radial faces of the first, second and/or third components need not be the same as those illustrated in FIGS. 1-4 and 6-12. The thickness and/or depth of the components need not be the same as those illustrated in FIGS., 1-4 and 6-12. The size, shape and/or location of the fastener arrangement and/or alignment arrangement need not be the same as those illustrated in FIGS. 4, 7 and 9. The size, shape and/or location of the further fastener arrangement 910 need not be the same as those illustrated in FIGS. 7 and 9.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavouring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. A die table segment for a tablet compression machine, the die table segment comprising:
a first component, for connection to a tablet compression machine, comprising an inner radial face having a first radius of curvature; and
a second component comprising an outer radial face with a second radius of curvature which is greater than the first radius of curvature, and a plurality of through holes for forming tablets.

2. The die table segment according to claim 1 comprising a fastener arrangement to couple the first and second components.

3. The die table segment according to claim 2, wherein the fastener arrangement directly couples the first and second components such that an outer radial face of the first component is in contact with an inner radial face of the second component when the first and second components are coupled.

4. The die table segment according to claim 2, wherein the fastener arrangement comprises at least one fastener which extends through the first component when the first and second components are coupled.

5. The die table segment according to claim 1, wherein the die table segment comprises at least one alignment arrangement to align the first and second components.

6. The die table segment according to claim 5, wherein the alignment arrangement comprises at least one male connector and cooperating female connector.

7. The die table segment according to claim 5, wherein the alignment arrangement comprises one or more pins, and wherein the first and second components each comprise respective holes for receiving the one or more pins.

8. The die table segment according to claim 7, wherein the one or more pins form an interference fit with the first component and form a push fit with the second component.

9. The die table segment according to claim 6, wherein the male connector of the alignment arrangement is formed on one of the first or second component, and the female connector is formed in the other component such that the male connector is received by the female connector when the first and second components are coupled.

10. The die table segment according to claim 1 comprising a third component having an inner radial face with a third radius of curvature substantially the same as the second radius of curvature and an outer radial face with a fourth radius of curvature, wherein the fourth radius of curvature is greater than the third radius of curvature.

11. The die table segment according to claim 10 comprising a further fastener arrangement to couple the second and third components.

12. The die table segment according to claim 11, wherein the further fastener arrangement comprises at least one fastener which extends radially through at least a portion of the third component when the second and third components are coupled together.

13. The die table segment according to claim 10, wherein the third component has a ledge, wherein the ledge extends to the outer radial face of the third component, and wherein the ledge is for receiving tablets.

14. The die table segment according to claim 10, wherein the third component is made from a material different than the first and second components.

15. The die table segment according to claim 10, wherein the third component is formed from plastic.

16. The die table segment according to claim 1, wherein the first component comprises at least one recirculation groove.

17. The die table segment according to claim 16, wherein the first component comprises a recirculation groove on each of an upper and lower face of the first component.

18. The die table segment according to claim 1, wherein the first component comprises at least one notch for fastening the first component to a tablet compression machine.

19. The die table segment according to claim 1, wherein the plurality of through holes of the second component are equally spaced.

20. The die table segment according to claim 1, wherein the plurality of through holes of the second component extend from an upper face to a lower face of the second component.

21. The die table segment according to claim 1, wherein at least a portion of the second component is coated.

22. The die table segment according to claim 21, wherein the coating is at least one of an anti-abrasion, an anti-stick, an anti-friction and/or an anti-corrosion coating.

23. The die table segment according to claim 1, wherein the first component is formed from a first material, and the second component is formed from a second material, wherein the first and second materials are different.

24. The die table segment according to claim 1, wherein the second component is formed from a material having a high corrosion and wear resistance.

25. A die table for a tablet compression machine, wherein the die table is formed from a plurality of die table segments according to any preceding claim, wherein the die table is formed when the plurality of die table segments is aligned circumferentially.
